(19) United States
(12) Patent Application Publication
(10) Pub. No.: US 2006/0068069 A1
(43) Pub. Date: Mar. 30, 2006

(54) Flaking plant for the production of flakes of fine powders

(75) Inventors: Paolo Marchi, Imola (IT); Alessandro Fabbroni, Faenza (IT)

Correspondence Address: BROWDY AND NEIMARK, P.L.L.C.;624 NINTH STREET, NW, SUITE 300, WASHINGTON, DC, 20001-5303, US

(73) Assignee: SACMI COOPERATIVA MECCANICI IMOLA SOCIETA' COOPERATIVA, Imola (IT)

(21) Appl. No.: 11/229,668

(22) Filed: Sep. 20, 2005

(30) Foreign Application Priority Data
Sep. 24, 2004 (IT) RE2004A000112

(51) Int. Cl. A23L 1/01

(52) U.S. Cl. 426/510

(57) ABSTRACT

A flaking plant (1) suitable for producing granular or atomised flakes of fine powders, comprising at least: a feeding system (3, 4) of said fine powders; means (5, 6) suitable for compacting said fine powders to obtain a uniform plate of cohesive material; and means for crushing said uniform plate, comprising a pair of opposite, parallel rotary shafts (9, 10), with which a first and second succession (11, 12) of coaxial discs (13) are respectively associated; the discs (13) belonging to said first succession (11) and the discs (13) belonging to said second succession (12) being spaced apart in the radial direction by an amount less than or equal to the thickness of the plate of cohesive material.

The present invention refers to a flaking plant for the production of flakes of granular or atomised fine powders, used in the ceramics industry.

In the processing cycles of raw materials for making tiles it is known, starting from granular or atomised powders, to form flakes, with which special chromatic effects are obtained in the finished product.

To produce said flakes, flaking plants are known in which an Archimedean screw feeds the incoherent powders to a pair of opposite motorised laminating cylinders, suitable for making a uniform plate of cohesive material, which is subsequently crushed, and separated into the desired flakes, through suitable means.

In particular, said crushing means generally comprise: a rotary paddle wheel consisting of a central shaft from which a plurality of identical longitudinal blades derive, arranged radially and equally angularly spaced; and a pair of interfacing rollers each of which carries a group of circumferential ribs that make a cutter; more specifically, the ribs associated with one of said rollers are staggered with respect to the ribs associated with the other, so that by radially intermeshing and coming into contact at their side surfaces, they can act as many shears.

The rotary paddle wheel is arranged parallel to the laminating cylinders and downstream of them, so that its longitudinal blades, as long as the laminating cylinders, divide the plate of cohesive material in a group of narrow and thin strips; said strips are then fed between the rollers where, thanks to the cutting action carried out by the ribs, they are further divided in the transversal direction obtaining small flakes thereof. The flakes, so as to be able to be effectively used in the production of tiles, must nevertheless be of a size falling within a given range, outside of which they cannot be used, and are therefore discarded.

A particularly notable drawback of known flaking plants lies in the fact that, due to the fragility of the plate of cohesive material, the crushing means produce a lot of waste material and, in particular, a very high percentage of material that is too fine to be used in the production of tiles.

This characteristics means low productivity of the flaking plant, resulting in long processing times and increased production costs.

Another notable drawback of the known flaking plants consists of the fact that said plants are unable to produce flakes all of the same size; on the other hand, they produce flakes distributed over a rather wide range of sizes.

For this reason, the production of flakes through known plants requires an auxiliary sifting step with which to separate and group together the flakes of similar size, to then be able to use them selectively according to the application and the chromatic effect that one wishes to make in the tile.

As a direct consequence of this, at the outlet of the crushing means, known flaking plants are equipped with a pile of sieves, having meshes of decreasing size from the top to the bottom, each of which is suitable for holding flakes of a similar size; this fact thus means a further complication of the plant and of its management, as well as an increase of the installation and production costs.

Finally, a third drawback lies in the fact that the crushing means of known flaking plants often become dirty with the materials being processed and, for this reason, make cleaning interventions necessary; said interventions can be of the manual type, with consequent interruption of production, or delegated to suitable cleaning devices that complicate the flaking plant itself and make it more expensive.

The purpose of the present invention is that of overcoming the aforementioned drawbacks in a simple, rational and low-cost solution.

Such a purpose is accomplished through a flaking plant comprising at least: a feeding system of the fine powders; means suitable for compacting said fine powders to obtain a uniform plate of cohesive material; and means for crushing said uniform plate, comprising a pair of opposite, parallel rotary shafts, with which a first and second succession of coaxial discs are respectively associated; the edges of the discs belonging to said first succession and the edges of the discs belonging to said second succession being spaced apart in the radial direction by an amount less than or equal to the thickness of the plate of cohesive material.

Thanks to this solution it is possible to obtain a drastic reduction in the percentage of fine material, an almost total elimination of the large flakes and, as a consequence of these two factors, a production of concentrated flakes in a very narrow range of sizes, allowing the final sieving operation to be eliminated.

According to a preferred embodiment of the invention the discs belonging to the first succession are staggered in the axial direction with respect to the discs belonging to the second succession; preferably, each disc of the first succession is not in contact with the adjacent discs of the second succession.

In this way, the crushing means according to the invention are self-cleaning, making any cleaning intervention, as well as the presence of devices intended for this task, superfluous.

According to a further embodiment of the invention, the perimetric edge of each disc has an acuminated profile, preferably with an angle at the vertex of 20°.

Moreover, according to said embodiment, the discs belonging to the first succession and those belonging to the second succession interpenetrate in the radial direction; said interpenetration is preferably less than 10 mm.

These provisions allow the production of flakes to be optimised both in terms of the percentage of waste produced, and in terms of the size distribution of the flakes themselves.

A further, and particularly advantageous, embodiment of the invention foresees that the discs belonging to at least one of said first and second succession have the perimetric edge with teeth.

By making this embodiment it is indeed possible to divide the plate of cohesive material both in the longitudinal and transversal direction with a single crushing operation, advantageously obtaining the desired flakes without using any other means besides said two successions of discs.

Another preferred embodiment of the invention foresees that each disc is dismountably associated with the corresponding rotary shaft; preferably, said embodiment foresees that each disc, being equipped with a central hole, has the corresponding rotary shaft slotted through it, and that it is spaced from the subsequent disc through the interposition of a spacer.

Thanks to this solution it is possible to mount the discs of variable size and profile according to the desired result.

Moreover, by simply varying the number and distance of the discs associated with each rotary shaft, it is advantageously possible to vary the size of the flakes that can be obtained at the outlet of the plant.

Finally, in accordance with a further embodiment of the invention, the flaking plant comprises means suitable for varying the interaxis between the two rotary shafts that carry the discs.

The dependent claims outline preferred and particularly advantageous embodiments of the invention.

Further characteristics and advantages of the invention shall become clear from reading the following description provided as an example and not for limiting purposes, with the help of the figures illustrated in the attached tables, in which:

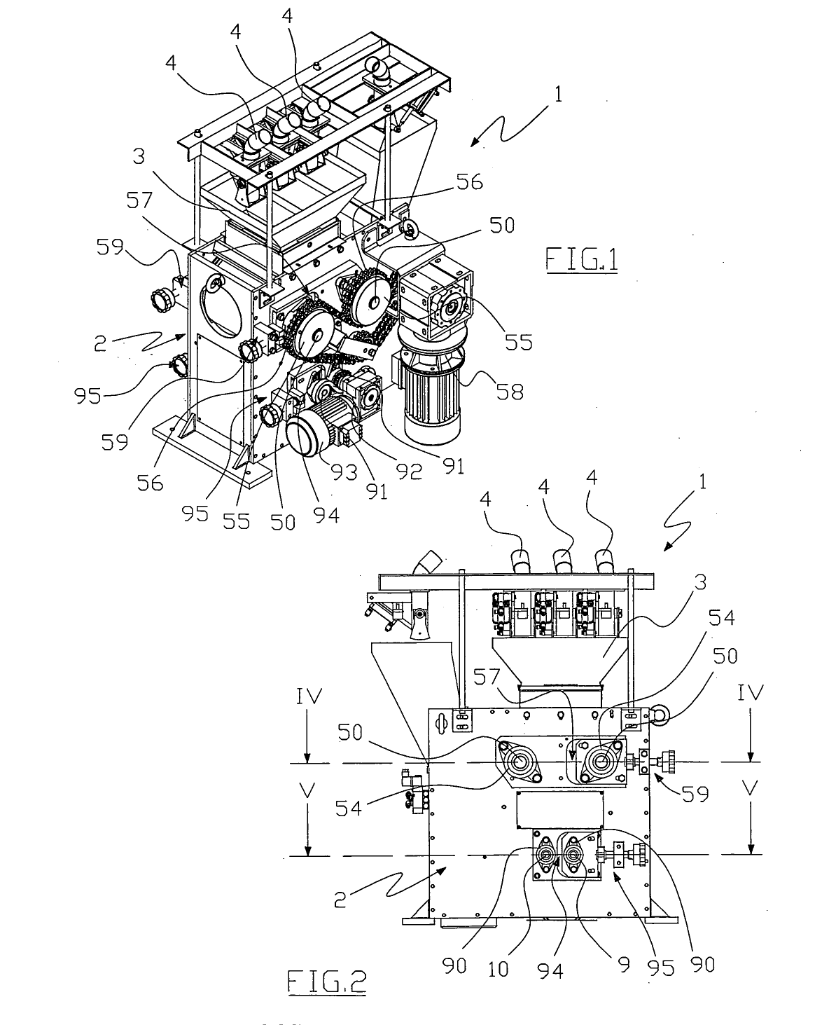

FIG. 1 is an axonometric view of a flaking plant in accordance with the invention;

FIG. 2 is a front view of the flaking plant of FIG. 1;

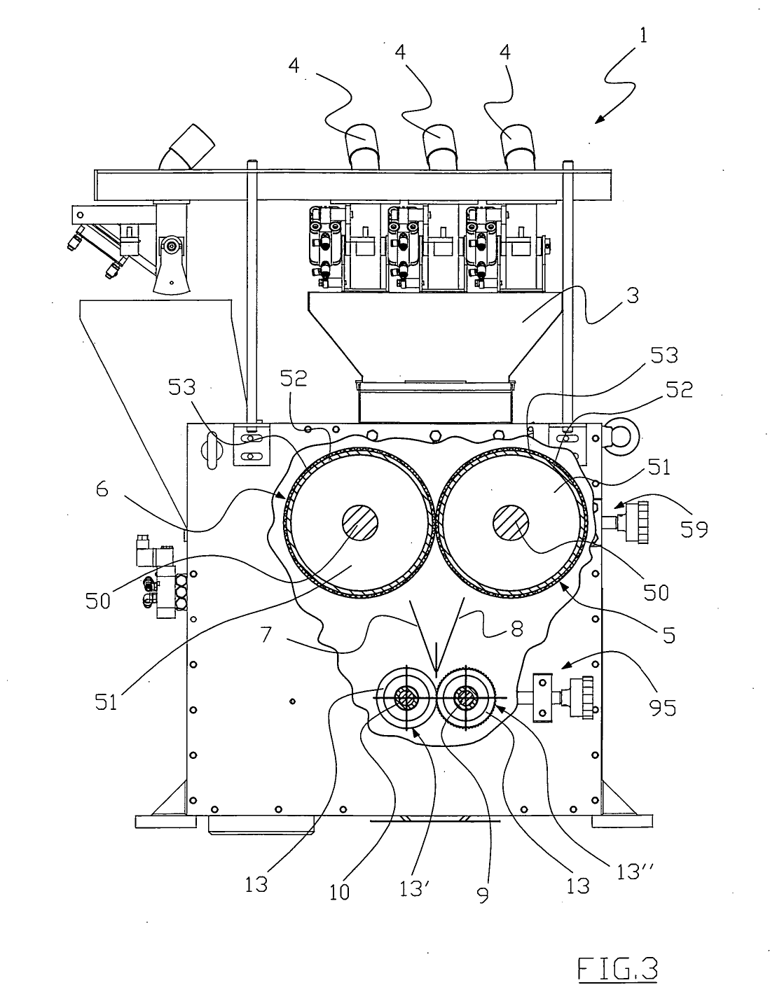

FIG. 3 is the enlarged view of FIG. 2, in which a section plane has been formed to highlight some details of the invention;

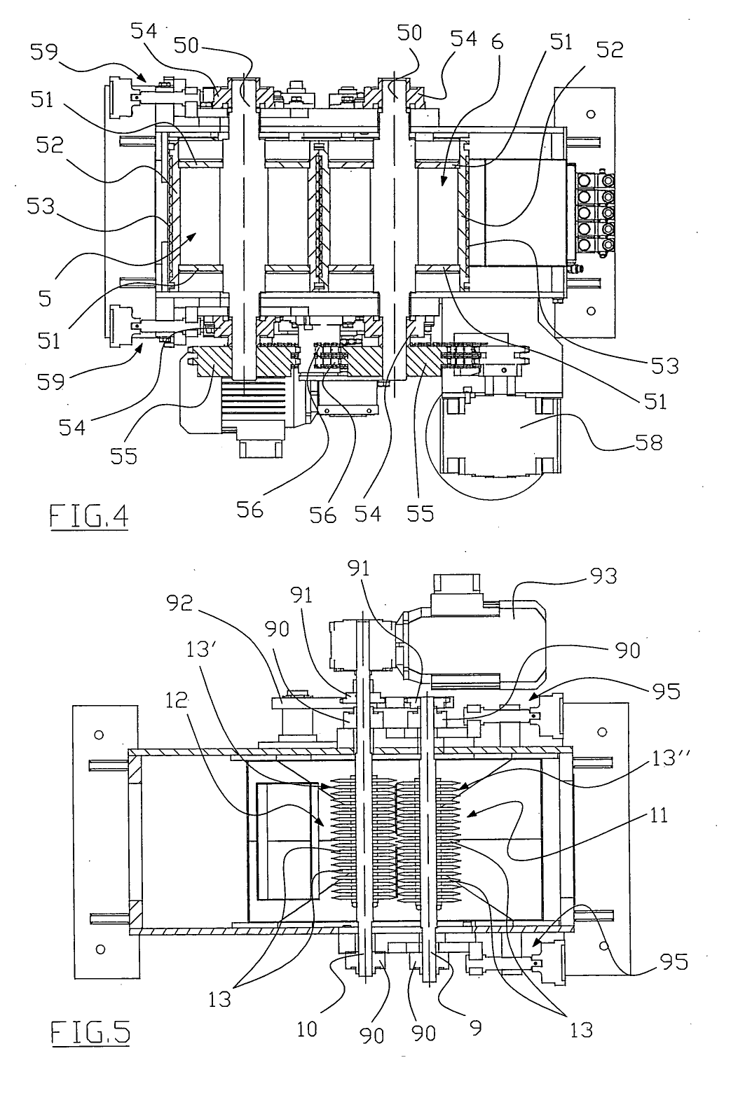

FIG. 4 is the section IV-IV of FIG. 2;

FIG. 5 is the section V-V of FIG. 2;

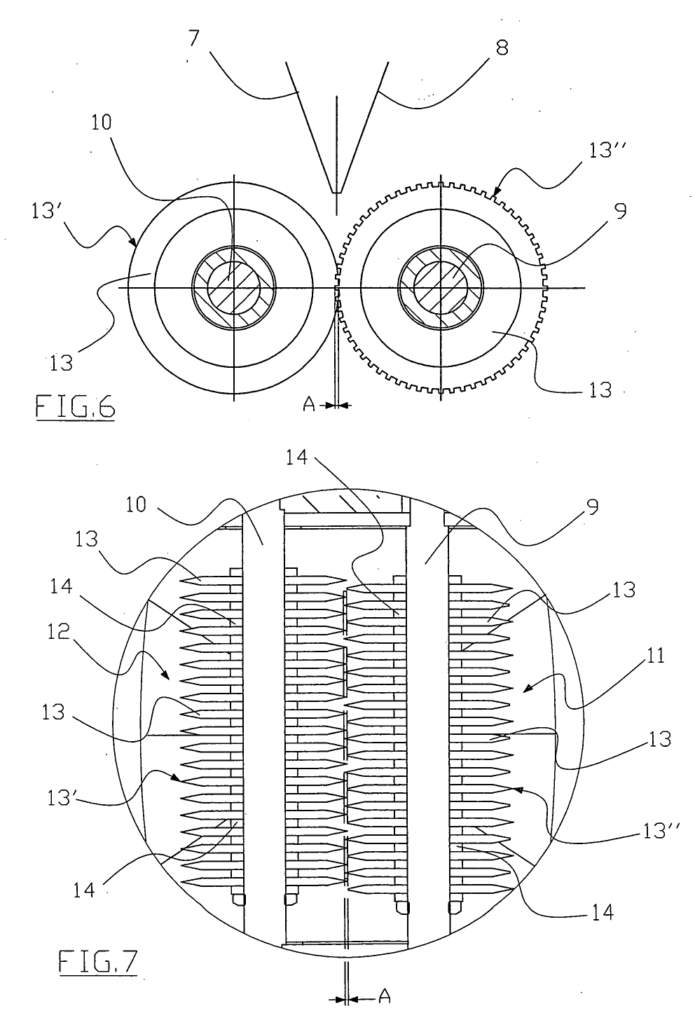

FIG. 6 is an enlarged detail of FIG. 3;

FIG. 7 is an enlarged detail of FIG. 5.

From the aforementioned figures it is possible to see a flaking plant 1 for the production of flakes from incoherent materials, such as granular or atomised fine powders.

Said flaking plant 1 comprises an outer casing 2 above which a feeding system of the incoherent materials is arranged that feeds means suitable for compacting said materials to obtain a uniform and cohesive plate, which is subsequently reduced into flakes through crushing means; said compacting means and crushing means are contained inside the outer casing 2.

In detail (see FIG. 3), the feeding system comprises a hopper 3 that conveys the incoherent materials, coming from dispensing devices 4 above, to a pair of identical interfacing laminating cylinders 5 and 6, each of which comprises a central shaft 50 with which it is made integral, through two rings 51, a hollow cylinder 52 (see FIG. 4); the outer surface of said hollow cylinder 52 has an annular groove that houses an elastomeric layer 53 suitable for coming into contact with the material being processed.

The central shaft 50 of each laminating cylinders 5 and 6 is supported at the ends by two supports 54 associated with the outer casing 2 of the flaking plant 1; in particular (see FIG. 1), on the same side of said outer casing 2, each central shaft 50 has a portion projecting to the outside, on which a toothed wheel 55 is fitted that receives the motion from a motor reducer 58, through a pair of chains 56.

More specifically, as can be seen in FIGS. 1 and 2, the supports 54 of the laminating cylinder 5, being mounted inside two respective slotted seats 57, can slide horizontally controlled by two respective screw devices 59, so as to position the cylinder 5 at an adjustable distance from the adjacent cylinder 6, according to the thickness of the flakes that one wishes to make.

Below said laminating cylinders 5 and 6, inside the casing 2 (see FIG. 3), the flaking plant 1 comprises two chutes, 7 and 8 respectively, converging towards the bottom and suitable for guiding the plate of cohesive material towards the crushing means.

In detail (see FIGS. 3 and 5), the crushing means comprise two parallel counter-rotating shafts, 9 and 10 respectively, with which a first and second succession 11 and 12 of discs 13 are respectively associated; said discs 13 are preferably made from metallic material, have the perimetric edge shaped so as to have an acuminated profile, and being equipped with a central hole, are coaxially fitted on the respective rotary shaft 9 or 10, spaced apart through interposition of suitable annular spacers 14.

In particular, as can be seen in FIGS. 5 and 7, the discs 13 respectively associated with the rotary shaft 9 and 10 are mutually staggered in the axial direction and interpenetrate, in the radial direction, by an amount A. It should be highlighted here that, in accordance with the invention, it is not strictly necessary for said discs 13 to interpenetrate, with it instead being sufficient for them to be spaced apart, in the radial direction, by an amount less than or equal to the thickness of the uniform plate produced by the laminating cylinders 5 and 6.

In detail, as can clearly be seen in FIG. 7, each disc 13 belonging to the first succession 11 is spaced in the axial direction, and without any point of contact, with respect to the discs 13 belonging to the second succession 12; in other words, a separation space is always defined between two consecutive discs 13.

In the specific case shown in the figures, both the first and the second succession 11 and 12 have discs 13 that are identical in shape and size, separated by a constant pitch and staggered apart substantially by half of said pitch with respect to the discs of the other succession.

The rotary shafts 9 and 10 are mounted, in the same way as the laminating cylinders 5 and 6, with the ends supported by two supports 90 associated with the outer casing 2 of the flaking plant 1; moreover, on the same side of the casing 2, each rotary shaft 9 and 10 projects to the outside for a portion at which a toothed wheel 91 is fitted that, through a toothed belt 92, is actuated in rotation by a motor reducer 93; said motor reducer 93 is suitable for simultaneously actuating both of the toothed wheels 91 and thus both of the rotary shafts 9 and 10.

Furthermore, the supports 90 of the rotary shaft 9, being mounted in two slotted seats 94, are suitable for sliding horizontally controlled by a respective screw adjustment device 95 so that said rotary shaft 9 can be brought closer to, or moved away from, the rotary shaft 10 so as to vary their interaxis according to requirements.

Finally, as can be seen in particular in FIG. 6, the discs 13 associated with the rotary shaft 10 have the perimetric edge 13′ continuous, whereas the discs 13 associated with the rotary shaft 9 have the perimetric edge 13″ toothed.

In use, the incoherent materials are fed by the dispensing devices 4, through the hopper 3, to the laminating cylinders 5 and 6 that, compacting them, make the uniform plate of cohesive material; said plate, guided by the chutes 7 and 8, is in turn conveyed between the discs 13 respectively associated with the rotary shaft 9 and with the rotary shaft 10.

As stated, the discs 13 associated with the rotary shaft 9 are not in contact with the discs 13 associated with the rotary shaft 10; therefore, said discs 13 are not suitable for acting as shears, but rather are suitable for generating an alternation of forces that is substantially localised and in opposite directions that, in turn, produce a plurality of bending effects on the plate of cohesive material.

Since said plate of cohesive material is by its nature fragile, said bending effects cause it to break perpendicularly to the plate itself; at the same time, the teeth of the toothed perimetric edge 13″ of the discs 13 associated with the rotary shaft 9, acting in succession, fracture it in the transversal direction.

In this way, without any subsequent operative step, the desired flakes are directly obtained, which are finally collected by suitable collection means that are arranged downstream of the discs 13 and not shown in the figures. It should be noted that by associating the discs 13 having the perimetric edge 13″ with a different number of teeth, i.e. with a different pitch between one tooth and the next, with the rotary shaft 9, it is possible to advantageously vary the size of the flakes that can be obtained.

Finally, it should be highlighted how the described flaking plant 1 has clearly superior characteristics of efficiency with respect to a known flaking plant; this fact clearly emerges from tests carried out by the Applicant and the results of which are shown hereafter. In particular, said tests were conducted by placing sieves with different sized meshes at the outlet of the flaking plant 1, so as to evaluate the sizes of the flakes that can be obtained and their percentage distribution.

Table A shows results obtained with a flaking plant 1 that has the following constructive characteristics: the discs 13 are made from steel, with a diameter equal to 100 mm, and acuminated profile with vertex angle of 20°; moreover, the discs 13 associated both with the rotary shaft 9 and with the rotary shaft 10 are spaced by a constant pitch equal to 8 mm, are mutually staggered by half a pitch and interpenetrate by 2 mm; finally, the discs 13 associated with the rotary shaft 9 are toothed and each of them has, in particular, 72 U-shaped teeth 1.8 mm deep.

TABLE A

| | | | | | | | | | |
|---|---|---|---|---|---|---|---|---|---|
| FLAKE | 8000 | 5600 | 4000 | 3000 | 2000 | 1000 | <1000 | Dispersed | Tot. |
| SIZE | | | | | | | | | |
| (μm) | | | | | | | | | |
| AMOUNT | 0.04 | 1.8 | 41.2 | 33.1 | 14.4 | 3.10 | 6.0 | 0.36 | 100 |
| (%) | | | | | | | | | |

| | |
|---|---|
| NOTES | Flake thickness: 1.4-1.7 mm |

The clearest advantages are: the drastic reduction in discarded fine material (<1000 μm), the almost total elimination of large flakes (greater than or equal to 5600 μm), and the highly concentrated size distribution of the flakes over a smaller range (3000 μm-4000 μm).

1. Flaking plant 1 suitable for producing granular or atomised flakes of fine powders, comprising at least:
a feeding system (3, 4) of said fine powders;
means (5, 6) suitable for compacting said fine powders to obtain a uniform plate of cohesive material; and
means for crushing said uniform plate, comprising a pair of opposite, parallel rotary shafts (9, 10), with which a first and second succession (11, 12) of coaxial discs (13) are respectively associated,
characterised in that the edges of the discs (13) belonging to said first succession (11) and the edges of the discs (13) belonging to said second succession (12) are spaced apart in the radial direction by an amount less than or equal to the thickness of the plate of cohesive material.

2. Flaking plant (1) according to claim 1, characterised in that the discs (13) belonging to the first succession (11) are staggered in the axial direction with respect to the discs (13) belonging to the second succession (12).

3. Flaking plant (1) according to claim 2, characterised in that each disc (13) of the first succession (11) is not in contact with the discs adjacent to it of the second succession (12).

4. Flaking plant (1) according to claim 1, characterised in that said discs (13) have a perimetric edge (13′, 13″) having an acuminated profile.

5. Flaking plant (1) according to claim 4, characterised in that said acuminated profile has an angle at the vertex substantially equal to 20°.

6. Flaking plant (1) according to claim 3, characterised in that the discs belonging to the first succession (11) and the discs belonging to the second succession (12) interpenetrate with each other in the radial direction.

7. Flaking plant (1) according to claim 6, characterised in that said interpenetration is less than 10 mm.

8. Flaking plant (1) according to claim 1, characterised in that the discs (13) belonging to at least one of said first and second succession (11, 12) have the perimetric edge (13″) toothed.

9. Flaking plant (1) according to claim 1, characterised in that each disc (13) is detachably associated with the respective rotary shaft (9, 10).

10. Flaking plant (1) according to claim 1, characterised in that each disc (13) has a central hole, through which it is suitable for being fitted onto the corresponding rotary shaft (9, 10).

11. Flaking plant (1) according to claim 1, characterised in that each disc (13) is spaced from the discs (13) adjacent to it on the same rotary shaft (9, 10), through the interposition of a spacer (14).

12. Flaking plant (1) according to claim 1, characterised in that said discs (13) are made from metallic material.

13. Flaking plant (1) according to claim 1, characterised in that it comprises means (90, 95) for varying the interaxis between the rotary shaft (9, 10) that respectively support said first and second succession (11, 12) of discs (13).

14. Flaking plant (1) according to claim 13, characterised in that said means for varying the interaxis between the rotary shaft (9, 10) comprise:
sliding supports (90) suitable for supporting at least one of the two rotary shaft (9, 10), and
screw adjustment devices (95) suitable for controlling the sliding of said supports (90).
